(19) United States
(12) Patent Application Publication
(10) Pub. No.: US 2026/0163005 A1
(43) Pub. Date: Jun. 11, 2026

(54) METHOD FOR MANUFACTURING NEGATIVE ELECTRODE SLURRY FOR ALL-SOLID-STATE BATTERY, NEGATIVE ELECTRODE SLURRY MANUFACTURED THEREBY, AND NEGATIVE ELECTRODE MANUFACTURED THEREBY

(71) Applicant: SAMSUNG SDI CO., LTD., Yongin-si (KR)

(72) Inventors: Bohyung LEE, Yongin-si (KR); Jangwook LEE, Yongin-si (KR); Seunghyun OH, Yongin-si (KR); Jiwon HAN, Yongin-si (KR)

(73) Assignee: SAMSUNG SDI CO., LTD., Yongin-si (KR)

(21) Appl. No.: 19/413,284

(22) Filed: Dec. 9, 2025

(30) Foreign Application Priority Data
Dec. 10, 2024 (KR) 10-2024-0182490

(51) Int. Cl. H01M 4/62; H01M 4/02; H01M 4/36

(52) U.S. Cl. CPC H01M 4/626; H01M 4/366; H01M 4/622; H01M 4/625; H01M 2004/021; H01M 2004/027

(57) ABSTRACT

The present disclosure relates to a method for preparing a negative electrode slurry for an all-solid-state battery, and a negative electrode slurry prepared using the method. More specifically, the present disclosure relates to a method for manufacturing a negative electrode slurry for an all-solid-state battery including forming a mixture by mixing a binder solution including a solvent and a first binder with a negative electrode material, performing a pre-dispersion process on the mixture to form a first slurry, and performing a main dispersion process on the first slurry to form a second slurry. The main dispersion process is performed by a high-pressure dispersion method under an operating pressure of about 500 bar or more.

### CROSS-REFERENCE TO RELATED APPLICATION

This application claims priority under 35 U.S.C § 119 to Korean Patent Application No. 10-2024-0182490 filed on Dec. 10, 2024 in the Korean Intellectual Property Office, the disclosure of which is hereby incorporated by reference in its entirety.

### BACKGROUND

The present disclosure relates to a method for manufacturing a negative electrode slurry for an all-solid-state battery, a negative electrode for an all-solid-state battery, and an all-solid-state battery.

With increasing industrial demand, the development of high-energy-density and highly safe batteries has been actively pursued. Lithium-ion batteries, for instance, have been widely commercialized not only for consumer electronics and communication devices, but also in the automotive industry. In automotive applications, battery safety is relevant due to the impact thereof on human safety.

All-solid-state batteries, which use a solid electrolyte instead of a liquid electrolyte, are proposed as a promising alternative. Unlike conventional lithium-ion batteries that contain flammable organic solvents, all-solid-state batteries significantly reduce the risk of fire or explosion, even in the event of a short circuit. As a result, all-solid-state batteries offer a substantial improvement in safety compared to lithium-ion batteries utilizing liquid electrolytes.

### SUMMARY

An example embodiment of the present disclosure includes a negative electrode slurry having improved dispersion characteristics and a method for producing the negative electrode slurry.

According to an example embodiment of the present disclosure, a method for manufacturing a negative electrode slurry for an all-solid-state battery may include forming a mixture by mixing a binder solution including a solvent and a first binder with a negative electrode material, performing a pre-dispersion process on the mixture to form a first slurry, and performing a main dispersion process on the first slurry to form a second slurry. The main dispersion process is performed by a high-pressure dispersion method under an operating pressure in a range of about 500 bar or more. In a two-dimensional image of the first slurry, the number of aggregates per 25 mm² is in a range about 30 or less, and a particle size of the aggregates is in a range about 50 μm or larger.

According to another example embodiment of the present disclosure, a method for manufacturing a negative electrode slurry for an all-solid-state battery may include forming a mixture by mixing a binder solution including a solvent and a first binder with a negative electrode material, performing a pre-dispersion process on the mixture to form a first slurry, and performing a main dispersion process on the first slurry to form a second slurry. The pre-dispersion process is performed using at least one of a high-pressure disperser and a bead mill. The main dispersion process is performed by a high-pressure dispersion method under an operating pressure in a range of about 500 bar or more.

According to an example embodiment of the present disclosure, a negative electrode slurry for an all-solid-state battery may be manufactured by the above manufacturing method. In a two-dimensional image of the negative electrode slurry, the number of aggregates per 25 mm² may be in a range of about 1 or less. A particle size of the aggregates is in a range of about 50 μm or larger. The aggregates include a carbon-based material and a metal particle.

### BRIEF DESCRIPTION OF DRAWINGS

FIG. 1 illustrates a cross-sectional view of an all-solid-state battery according to example embodiments of the present disclosure.

FIG. 2 illustrates a flow chart showing a method for manufacturing a negative electrode slurry according to example embodiments of the present disclosure.

FIG. 3 and FIG. 4 respectively illustrate schematic diagrams of each step in the manufacturing method shown in FIG. 2.

FIG. 5 illustrates a plan view of an enlarged portion of a mixture according to an example embodiment of the present disclosure.

FIG. 6 and FIG. 7 respectively illustrate schematic diagrams of each step in the manufacturing method shown in FIG. 2.

FIG. 8 illustrates a plan view of an enlarged portion of a first slurry according to an example embodiment of the present disclosure.

FIG. 9 illustrates a schematic diagram of one step in the manufacturing method shown in FIG. 2.

FIG. 10 illustrates a plan view of an enlarged portion of a coating slurry according to an example embodiment of the present disclosure.

FIG. 11 illustrates an optical microscope image of the first slurry of Embodiment 1.

FIG. 12 illustrates an optical microscope image of the first slurry of Embodiment 2.

FIG. 13 illustrates an optical microscope image of the first slurry of Comparative Embodiment 1.

### DETAILED DESCRIPTION OF EMBODIMENTS

To fully understand the configuration and effects of the present disclosure, some example embodiments are described with reference to the accompanying drawings. However, the present disclosure is not limited to the following example embodiments and may be implemented in various forms. The example embodiments are provided solely to illustrate the present disclosure and to enable those skilled in the art to fully understand its scope.

In this description, when an element is described as being “on” another element, the element may be directly on the other element, or one or more intervening elements may be present therebetween. In the drawings, certain thicknesses may be exaggerated to better illustrate technical details. Throughout the specification, like reference numerals indicate like elements.

The example embodiments described herein may be illustrated using sectional and/or plan views, which are presented as idealized examples of the present disclosure. The thicknesses of layers and regions in the drawings may be exaggerated for clarity. The regions shown in the drawings are for illustrative purposes and should not be construed as limiting the scope of the present disclosure. Although terms such as “first,” “second,” and “third” may be used to describe various elements, these terms are merely for distinction and do not imply any particular order or hierarchy. The example embodiments described and illustrated herein include complementary variations.

The terms used in this description serve only to explain various example embodiments and are not intended to limit the present disclosure. Unless explicitly stated otherwise, singular forms may also include plural forms. The terms “comprises/includes” and “comprising/including” do not exclude the presence or addition of one or more other components.

In this description, the phrase “combination thereof” may refer to a mixture, a stack, a composite, a copolymer, an alloy, a blend, or a reaction product.

The phrases “A or B,” “at least one of A and B,” “at least one of A or B,” “A, B, or C,” “at least one of A, B, and C,” and “at least one of A, B, or C” include any one or all possible combinations of the listed elements.

Unless otherwise specifically defined, the term “particle diameter” refers to an average particle diameter. The particle diameter may represent the median particle size (D₅₀), which corresponds to the diameter of particles at 50 vol % in a cumulative particle size distribution. The average particle diameter (D₅₀) can be measured using widely known methods, such as a particle size analyzer, transmission electron microscope (TEM) imaging, or scanning electron microscope (SEM) imaging. Alternatively, dynamic light scattering may be used, where particle counts within size ranges are analyzed to calculate the average particle diameter (D₅₀). Additionally, a laser scattering method may be employed, in which a target particle is dispersed in a solvent, introduced into a laser scattering particle measurement device (e.g., MT3000 from Microtrac, Inc.), irradiated with ultrasonic waves at 28 kHz and 60 W, and subsequently analyzed to determine the D₅₀ value based on a 50% cumulative particle size distribution.

In some example embodiments, the average particle diameter may be determined by randomly or non-systematically selecting 100 or more particles from an electron microscope image. Alternatively, the average particle diameter may be measured using a particle size analyzer and defined as the diameter corresponding to 50 vol % in a cumulative particle size distribution.

The area of a circle having a diameter of 50 μm, as used in the present disclosure, is given by π/4×50² μm², which is approximately 1963.5 μm².

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

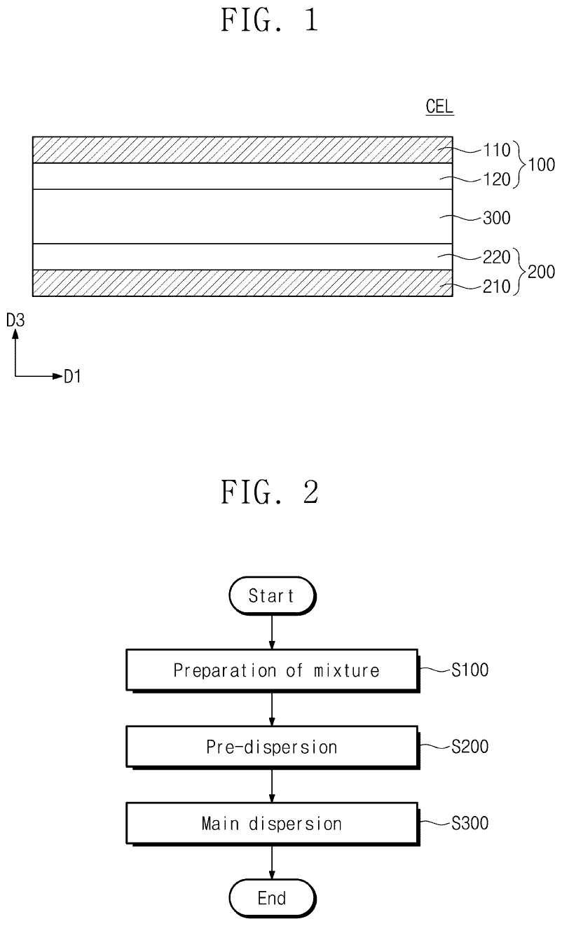

FIG. 1 illustrates a cross-sectional view of an all-solid-state battery according to example embodiments of the present disclosure.

Referring to FIG. 1, a unit cell CEL of an all-solid-state battery according to the present disclosure may include a positive electrode layer 100, a negative electrode layer 200 opposite to the positive electrode layer 100, and a solid electrolyte layer 300 disposed between the positive electrode layer 100 and the negative electrode layer 200. The present disclosure, however, is not limited thereto, and the unit cell CEL may further include an additional functional layer, such as an adhesion enhancement layer, disposed between the positive electrode layer 100 and the solid electrolyte layer 300, or between the negative electrode layer 200 and the solid electrolyte layer 300.

### Positive Electrode Layer 100

The positive electrode layer 100 according to an example embodiment of the present disclosure may include a positive electrode current collector 110 and a positive electrode active material layer 120 disposed on the positive electrode current collector 110.

The positive electrode current collector 110 may provide a reference surface on which the positive electrode active material layer 120 is disposed. The positive electrode current collector 110 may include a plate or foil including, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Differently from that shown in FIG. 1, in an example embodiment of the present disclosure, the positive electrode current collector 110 may not be provided. Although not shown, to increase adhesion between the positive electrode current collector 110 and the positive electrode active material layer 120, a carbon layer having a thickness in a range of about 0.1 μm to about 4 μm may further be disposed between the positive electrode current collector 110 and the positive electrode active material layer 120.

### Positive Electrode Active Material Layer 120

The positive electrode active material layer 120 according to an example embodiment of the present disclosure may include a positive electrode active material and a solid electrolyte.

The positive electrode active material of the positive electrode active material layer 120 may include a material that can reversibly absorb and desorb lithium ions. The positive electrode active material may include a plurality of particles. For example, the positive electrode active material may include at least one of a lithium transition metal oxide (e.g., lithium cobalt oxide (LCO), lithium nickel oxide, lithium nickel cobalt oxide, lithium nickel cobalt aluminum oxide (NCA), lithium nickel cobalt manganese oxide (NCM), lithium manganate, or lithium iron phosphate), a nickel sulfide, a copper sulfide, a lithium sulfide, an iron oxide, or a vanadium oxide, but the present disclosure is not limited thereto. The positive electrode active material may be used alone, or in a mixture of two or more substances.

The lithium transition metal oxide may be or include, for example, a compound represented by one of LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}B_{b}O_{4-c}D_{c} (where 0≤b≤0.5 and 0≤c≤0.05), LiₐNi_{1-b-c}Co_{b}B_{c}D_{α} (where 0.90≤a≤1, 0≤b≤0.5, 0≤c≤0.05, and 0≤α≤2), LiₐNi_{1-b-c}Co_{b}B_{c}O_{2-α}F_{α} (where 0.90≤a≤1, 0≤b≤0.5, 0≤c≤0.05, and 0<α<2), LiₐNi_{1-b-c}Mn_{b}B_{c}D_{α} (where 0.90≤a≤1, 0≤b≤0.5, 0≤c≤0.05, and 0<α≤2), LiₐNi_{1-b-c}Mn_{b}B_{c}O_{2-α}F_{α} (where 0.90≤a≤1, 0≤b≤0.5, 0≤c≤0.05, and 0<α<2), LiₐNi_{b}E_{c}G_{d}O₂ (where 0.90≤a≤1, 0≤b≤0.9, 0≤c≤0.5, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001≤e≤0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (where 0≤f≤2), Li_{3-f}Fe₂(PO₄)₃ (where 0≤f≤2), and LiFePO₄. In the compounds above, “A” may be or include at least one of Ni, Co, Mn, or a combination thereof, “B” may be or include at least one of Al, Ni, Co, Mn, Cr, Fe, Mg, Sr, V, a rare-earth element, or a combination thereof, “D” may be or include at least one of O, F, S, P, or a combination thereof, “E” may be or include at least one of Co, Mn, or a combination thereof, “F” may be or include at least one of F, S, P, or a combination thereof, “G” may be or include at least one of Al, Cr, Mn, Fe, Mg, La, Ce, Sr, V, or a combination thereof, “Q” may be or include at least one of Ti, Mo, Mn, or a combination thereof, “I” may be or include at least one of Cr, V, Fe, Sc, Y, or a combination thereof, and “J” may be or include at least one of V, Cr, Mn, Co, Ni, Cu, or a combination thereof.

The positive electrode active material may include, for example, a lithium salt of transition metal oxide having a layered rock salt type structure among lithium transition metal oxides discussed above. The term “layered rock salt type structure” may refer to a structure in which an oxygen atom layer and a metal atom layer are alternately and regularly arranged in a <111> direction of a cubic rock salt type structure, where each atom layer forms a two-dimensional plane. The term “cubic rock salt type structure” may refer to a sodium chloride (NaCl) type structure, which is a type of crystal structure, and for example, has a structure in which face centered cubic lattices (FCCs) each formed of cations and anions are arranged displaced from each other by ½ (half) of a ridge of a unit lattice. The lithium transition metal oxide having the layered rock salt type structure may be or include a ternary lithium transition metal oxide, such as LiNiₓCo_{y}Al_{z}O₂ (NCA) or LiNiₓCo_{y}Mn_{z}O₂ (NCM) (where 0<x<1, 0<y<1, 0<z<1, and x+y+z=1). When the positive electrode active material includes a ternary lithium transition metal oxide having the layered rock salt type structure, the unit cell CEL may have increased energy density and improved thermal stability.

The compound included in the positive electrode active material may be covered with a coating layer (not shown). The positive electrode active material may be used in a mixture of the compound and a compound to which the coating layer is added. The coating layer added to a surface of the positive electrode active material may include, for example, at least one of oxide, hydroxide, oxyhydroxide, oxycarbonate, or hydrocarbonate of a coating element discussed below. The compound that constitutes the coating layer may be amorphous or crystalline. The coating element included in the coating layer may include at least one of Mg, Al, Co, K, Na, Ca, Si, Ti, V, Sn, Ge, Ga, B, As, Zr, or a mixture thereof. The coating layer may include, for example, Li₂O—ZrO₂ (LZO). A method for forming the coating layer may be determined from any methods that do not adversely affect physical characteristics of the positive electrode active material. The method of forming the coating layer may include, for example, spray coating or immersion.

When the positive electrode active material includes nickel (Ni) as a ternary lithium transition metal oxide such as NCA or NCM, a capacity density of the unit cell CEL may increase to reduce metal elution from the positive electrode active material in a charged state. Therefore, the unit cell CEL may improve in cycle characteristics in a charged state. The language “cycle characteristics” may refer to properties that indicate the degree to which the unit cell CEL is degraded due to charge and discharge. For example, the unit cell CEL with high cycle characteristics may degrade less due to charge and discharge, while the unit cell CEL with low cycle characteristics may degrade more due to charge and discharge.

The positive electrode active material may have, for example, a spherical or oval particle shape. There is no limitation on a particle diameter and an amount of the positive electrode active material.

The solid electrolyte of the positive electrode active material layer 120 may have a particle shape. The solid electrolyte may be dispersed between the positive electrode active materials. The solid electrolyte may include a sulfide-based solid electrolyte with desired or improved lithium ionic conductivity. The sulfide-based solid electrolyte may include, for example, at least one of Li₂S—P₂S₅, Li₂S—P₂S₅—LiX (where X is or includes a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ (where m and n are each a positive integer, and “Z” is or includes at least one of Ge, Zn, and Ga), Li₂S—GeS₂, Li₂S—SiS₂—Li₃PO₄, Li₂S—SiS₂—LiₚMO_{q} (where p and q are each a positive integer, and “M” is or includes at least one of P, Si, Ge, B, Al, Ga, and In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

The sulfide-based solid electrolyte may be or include an argyrodite-type compound including, for example, at least one of Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be or include an argyrodite-type compound including at least one of Li₆PS₅Cl, Li₆PS₅Br, and Li₆PS₅I.

Alternatively, the sulfide-based solid electrolyte may be or include an argyrodite-type compound including Li_{7-a-c}MₐPS₆₋ₓX_{c} (where 0≤a≤2 and 0≤c≤2). In the chemical formula above, X may be or include at least one of F, Br, Cl, or a combination thereof. M may be or include at least one of scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (Tl), silicon (Si), germanium (Ge), tin (Sn), lead (Pb), arsenic (As), antimony (Sb), bismuth (Bi), or a combination thereof.

The argyrodite-type solid electrolyte may have a density in a range of about 1.5 g/cc to about 2.0 g/cc. As the argyrodite-type solid electrolyte has a density of equal to or greater than about 1.5 g/cc, it may be possible to decrease an internal resistance of an all-solid-state battery and to hinder or prevent a solid electrolyte layer from short-circuit and penetration caused by the formation of lithium dendrites. The solid electrolyte may have an elastic modulus in a range of, for example, about 15 GPa to about 35 GPa.

The solid electrolyte in the positive electrode active material layer 120 may have an average particle diameter that is less than the average particle diameters of first and second electrolytes in the solid electrolyte layer 300, which are discussed below. For example, the average particle diameter of the solid electrolyte in the positive electrode active material layer 120 may be about equal to or less than about 90%, 80%, 70%, 60%, 50%, 40%, 30%, or 20% of the average particle diameter of a solid electrolyte included in the solid electrolyte layer 300. The average particle diameter may be a median diameter measured with a laser-type particle size distribution analyzer.

The positive electrode active material layer 120 may include a conductive material. The conductive material may have conductivity without causing a chemical change of the unit cell CEL to increase conductivity of the positive electrode active material and the solid electrolyte. The conductive material may include a carbon-based material. The conductive material may include, for example, one or more of graphite, carbon black, acetylene black, carbon nano-fiber, and carbon nano-tube.

The positive electrode active material layer 120 may further include a binder. The binder may combine the positive electrode active material, the solid electrolyte, and the conductive material together in the positive electrode active material layer 120. The binder may include a material that improves adhesion between the positive electrode active material layer 120 and the positive electrode current collector 110. For example, the binder may include at least one of polyvinylidenefluoride, styrene-butadiene rubber (SBR), polytetrafluoroethylene, polyvinylidenefluoride, vinylidenefluoride/hexafluoropropylene copolymer, polyacrylonitrile, and polymethylmethacrylate.

Based on the total 100 parts by weight of the positive electrode active material, the solid electrolyte, the conductive material, and the binder, the positive electrode active material may be included in an amount in a range of about 85 parts by weight to about 92 parts by weight in the positive electrode active material layer 120. Based on the total 100 parts by weight of the positive electrode active material, the solid electrolyte, the conductive material, and the binder, the binder may be included in an amount in a range of about 0.5 parts by weight to about 1.5 parts by weight in the positive electrode active material layer 120.

Based on 100 parts by weight of the solid electrolyte, the conductive material may be included in an amount in a range of about 1 part by weight to about 50 parts by weight in the positive electrode active material layer 120. When the conductive material is included in an amount that is less than about 1 part by weight relative to 100 parts by weight of the solid electrolyte, a proportion of the conductive material may decrease and reduce an electrical conductivity of the positive electrode active material layer 120. When the conductive material is included in an amount of greater than about 50 parts by weight relative to 100 parts by weight of the solid electrolyte, a proportion of the conductive material may excessively increase and cause incomplete formation of a coating layer that covers a surface of the solid electrolyte.

The positive electrode active material layer 120 may further include an additive, such as at least one of a filler, a coating agent, a dispersant, and an ionic conductivity agent, in addition to the positive electrode active material, the solid electrolyte, the conductive material, and the binder.

### Negative Electrode Layer 200

The negative electrode layer 200 may include a negative electrode current collector 210 and a coating layer 220 on the negative electrode current collector 210. The negative electrode current collector 210 may provide a reference surface on which the coating layer 220 is disposed. The negative electrode current collector 210 may include a material that does not react with lithium, for example, a material that does not form an alloy or a compound with lithium. For example, the negative electrode current collector 210 may include at least one of copper (Cu), stainless steel, titanium (Ti), iron (Fe), cobalt (Co), nickel (Ni), and an alloy thereof. For example, a thickness of the negative electrode current collector 210 may range from about 1 μm to about 20 μm, from about 5 μm to about 15 μm, or from about 7 μm to about 10 μm.

The negative electrode current collector 210 may be formed of or include one of the metals mentioned above, an alloy of two or more of the metals mentioned above, or a coating material. The negative electrode current collector 210 may have, for example, a plate or foil shape. In an example embodiment, the negative electrode current collector 210 may not be provided.

### Coating Layer 220

The coating layer 220 may induce growth of lithium metal between the coating layer 220 and the negative electrode current collector 210 when the unit cell CEL is charged. The coating layer 220 may constitute a protection layer for lithium metal and simultaneously or contemporaneously may reduce or suppress precipitation and growth of lithium dendrites.

The coating layer 220 may include metal and carbon. For example, the coating layer 220 may include at least one metal such as or including one of gold (Au), platinum (Pt), palladium (Pd), silicon (Si), silver (Ag), aluminum (Al), bismuth (Bi), tin (Sn), and zinc (Zn). The coating layer 220 may include at least one carbon such as or including one of carbon black, acetylene black, furnace black, ketjen black, and graphene. In an example embodiment, the coating layer 220 may include a mixture (or composite) of carbon black and silver (Ag).

The coating layer 220 may further include an additive in addition to metal and carbon. The coating layer 220 may include at least one additive such as or including at least one of, for example, a binder, a filler, a coating agent, a dispersant, and an ionic conductivity agent.

The coating layer 220 may have a thickness that is less than the thickness of the positive electrode active material layer 120. For example, the coating layer 220 may have a thickness that is equal to or less than about 50%, 40%, 30%, 20%, 10%, or 5% of the thickness of the positive electrode active material layer 120. The thickness of the coating layer 220 may range, for example, from about 1 μm to about 100 μm, from about 2 μm to about 80 μm, from about 10 μm to about 50 μm, or from about 5 μm to about 20 μm. When the coating layer 220 has an excessively small thickness, e.g., less than about 1 μm, lithium dendrites formed between the coating layer 220 and the negative electrode current collector 210 may collapse the coating layer 220 to reduce cycle characteristics of the unit cell CEL. When the coating layer 220 has an excessively large thickness, e.g., more than about 100 μm, the unit cell CEL may have a reduced energy density, and an internal resistance of the unit cell CEL may increase due to the coating layer 220, thereby reducing cycle characteristics of the unit cell CEL. Although not shown, a carbon layer may further be included to increase adhesion between the coating layer 220 and the solid electrolyte layer 300.

The coating layer 220 according to example embodiments of the present disclosure may be produced using the method for manufacturing a negative electrode slurry for an all-solid-state battery, which is described below with reference to FIG. 4.

The negative electrode layer 200 may further include a lithium metal layer (not shown) between the negative electrode current collector 210 and the coating layer 220. The lithium metal layer may have an increased thickness when the unit cell CEL is charged. The coating layer 220 may constitute a protection layer for the lithium metal layer and simultaneously or contemporaneously may reduce or suppress growth of lithium dendrites from the lithium metal layer.

The lithium metal layer may be or include a metal thin layer including lithium or lithium alloy. As the lithium metal layer includes lithium, the lithium metal layer may constitute, for example, a lithium reservoir. The lithium alloy may be or include, for example, at least one of Li—Al alloy, Li—Sn alloy, Li—In alloy, Li—Ag alloy, Li—Au alloy, Li—Zn alloy, Li—Ge alloy, or Li—Si alloy, but any suitable lithium alloys may be applicable. The lithium metal layer may be formed of or include lithium, one of the alloys, or several types of the alloys. The lithium metal layer may be or include, for example, a plated layer. For example, the lithium metal layer may be plated (or deposited) between the coating layer 220 and the negative electrode current collector 210 during charging of the unit cell CEL.

In another example embodiment of the present disclosure, the lithium metal layer in the negative electrode 200 may be provided between the negative electrode current collector 210 and the coating layer 220, for example, before the unit cell CEL is assembled. When the lithium metal layer is disposed between the negative electrode current collector 210 and the coating layer 220 before the unit cell CEL is assembled, the lithium metal layer may be or include a metal layer including lithium, and thus constitutes a lithium reservoir. For example, before the unit cell CEL is assembled, a lithium foil may be placed between the negative electrode current collector 210 and the coating layer 220.

When the lithium metal layer is deposited by charging after assembling the unit cell CEL, the energy density of the unit cell CEL may be increased because the unit cell CEL does not include the lithium metal layer at the time of assembling. When the unit cell CEL is charged, the charging capacity of the coating layer 220 may be exceeded. That is, the coating layer 220 is overcharged. In the early stage of charging, lithium may be occluded in the coating layer 220. When charging is performed in excess of the capacity of the coating layer 220, for example, lithium may be deposited between the negative electrode coating layer 220 and the negative electrode current collector 210. As a result, the metal layer may be formed by the deposited lithium.

The lithium metal layer may be mainly composed of or include lithium (i.e., metal lithium). During discharge, lithium in the lithium metal layer may be ionized and migrate to the positive electrode 100. In other words, lithium may constitute the negative electrode active material in the unit cell CEL. In addition, because the coating layer 220 covers the lithium metal layer, the coating layer 220 may protect the lithium metal layer and reduce or suppress precipitation growth of lithium dendrite. Accordingly, the coating layer 220 may reduce or suppress a short circuit and a decrease in capacity of the unit cell CEL and improve the cycle characteristics of the unit cell.

When the lithium metal layer is formed by charging after assembly of the unit cell CEL, the negative electrode 200 (including the negative electrode current collector 210, the coating layer 220, and a region between them) may be or include a Li-free region that does not include lithium (Li) in an initial state or a state after complete discharge of the unit cell CEL.

Although not shown, a carbon layer for improving adhesion may be further included between the coating layer 220 and the solid electrolyte layer 300. A more specific description of the coating layer 220 according to example embodiments of the present disclosure is described below with reference to FIG. 4.

### Solid Electrolyte Layer 300

The solid electrolyte layer 300 may be provided between the positive electrode layer 100 and the negative electrode layer 200. The solid electrolyte layer 300 may include a sulfide-based solid electrolyte with desired or improved lithium ionic conductivity. The solid electrolyte included in the solid electrolyte layer 300 may include a material that is the same as, or different from, the material of the solid electrolyte included in the positive electrode active material layer 120.

The solid electrolyte included in the solid electrolyte layer 300 may have a spherical or oval particle shape. The solid electrolyte may be in an amorphous state, a crystalline state, or a mixed state of amorphous and crystalline states. The solid electrolyte may include at least one of sulfur(S), phosphorus (P), and lithium (Li) among component elements included in the sulfide-based solid electrolyte mentioned above. For example, the solid electrolyte may be or include a material including Li₂S—P₂S₅. When Li₂S—P₂S₅ is utilized as the sulfide-based solid electrolyte material of the solid electrolyte, a mixing molar ratio of Li₂S and P₂S₅ may be in a range of about 50:50 to about 90:10.

In an example embodiment, the first solid electrolyte may include an argyrodite-type compound including, for example, at least one of Li₇₋ₓPS₆₋ₓClₓ (where 0≤x≤2), Li₇₋ₓPS₆₋ₓBrₓ (where 0≤x≤2), and Li₇₋ₓPS₆₋ₓIx (where 0≤x≤2). For example, the sulfide-based solid electrolyte may be or include an argyrodite-type compound including at least one of Li₆PS₅Cl, Li₆PS₅Br, and Li₆PS₅I.

Alternatively, the first solid electrolyte may include an argyrodite-type compound including Li_{7-a-c}MₐPS₆₋ₓX_{c}. In the chemical formula above, X may be or include at least one of Cl, Br, or a combination thereof. M may be or include at least one of Na, K, Fe, Mg, Ca, Ag, Cu, Zr, Zn, or a combination thereof. The subscripts “a” and “c” may each be a real number in a range of 0 to 2.

The argyrodite-type solid electrolyte may have a density in a range of about 1.5 g/cc to about 2.0 g/cc. As the argyrodite-type solid electrolyte has a density that is equal to or greater than about 1.5 g/cc, it may be possible to decrease an internal resistance of an all-solid-state battery and to hinder or prevent a solid electrolyte layer from short-circuit and penetration caused by the formation of lithium dendrites. The first solid electrolyte may have a modulus in a range of, for example, about 15 GPa to about 35 GPa.

The first solid electrolyte layer 310 may further include a binder. The binder included in the first solid electrolyte layer 310 may include, for example, at least one of styrene-butadiene rubber (SBR), polytetrafluoroethylene, polyvinylidenefluoride, or polyethylene, but the present disclosure is not limited thereto. The binder of the first solid electrolyte layer 310 may be the same as, or different from, the binder of the positive electrode active material layer 120 or that of the coating layer 220.

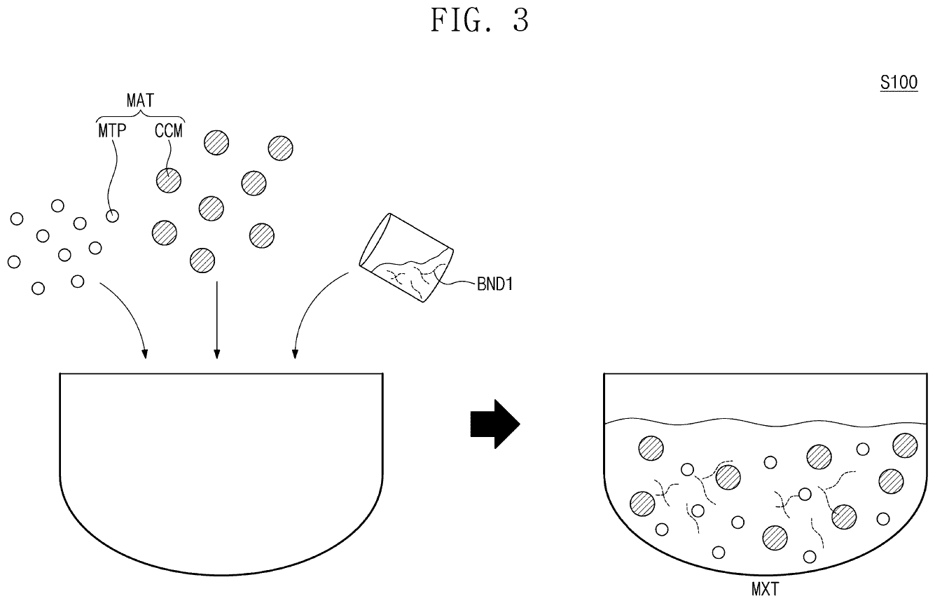

FIG. 2. illustrates a flow chart showing a method for manufacturing a negative electrode slurry according to example embodiments of the present disclosure. Hereinafter, a method for manufacturing a negative electrode slurry according to example embodiments of the present disclosure, a negative electrode for an all-solid-state battery produced by the method, and an all-solid-state battery including the negative electrode are described in detail below.

### Method for Manufacturing Negative Electrode Slurry

Referring to FIG. 2, a method for manufacturing a negative electrode slurry for an all-solid-state battery according to an example embodiment of the present disclosure may include forming a mixture by mixing a binder solution including a solvent and a first binder with a negative electrode material (S100), performing a pre-dispersion process on the mixture to form a first slurry (S200), and performing a main dispersion process on the first slurry to form a second slurry (S300).

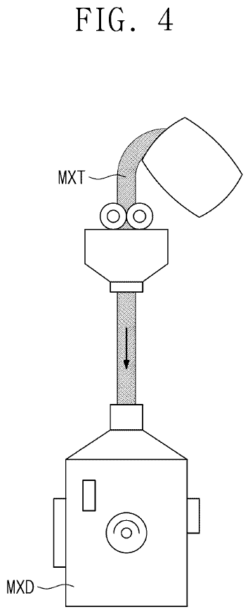

Referring to FIG. 2 and FIG. 3, forming the mixture MXT (S100) may include dissolving the first binder BND1 in a solvent to form a binder solution, and mixing the binder solution with the negative electrode material MAT.

The first binder BND1 may include at least one of acrylate-based binder, polyvinylidenefluoride-based binder, polyvinylpyrrolidone-based binder, cellulose-based binder and a combination thereof. The first binder BND1 may increase the viscosity of the mixture to form the mixture in slurry form.

The acrylate-based binder may be or include, for example, at least one of polyacrylic acid (PAA), polymethylmethacrylate, polyisobutylmethacrylate, polyethylacrylate, polybutyl acrylate, or poly(2-ethylhexyl acrylate).

The polyvinylidenefluoride-based binder may be or include, for example, at least one of polyvinylidenefluoride (PVDF), poly(vinylidenefluoride-co-hexafluoropropylene), poly(vinylidenefluoride-co-trichloroethylene), poly(vinylidenefluoride-co-tetrafluoroethylene), poly(vinylidenefluoride-co-trifluoroethylene), poly(vinylidenefluoride-co-trifluorochloroethylene), poly(vinylidenefluoride-co-ethylenefluoride-hexafluoropropylene), or polyvinylidenefluoride-co-trichloroethylene.

The polyvinylpyrrolidone-based binder may be or include, for example, polyvinylpyrrolidone. The polyvinylalcohol-based binder may be or include, for example, polyvinylalcohol.

The cellulose-based binder may be or include, for example, at least one of carboxymethyl cellulose (CMC), methyl cellulose (MC), hydroxypropyl cellulose (HPC), methyl hydroxypropyl cellulose (MHPC), ethyl hydroxyethyl cellulose (EHEC), methyl ethyl hydroxyethyl cellulose (MEHEC), or cellulose gum. In an example embodiment, the first binder BND1 may include carboxymethylcellulose (CMC).

The solvent may be or include an aqueous solvent or a non-aqueous solvent. In an example embodiment, the solvent may be or include water. In this description, the aqueous solvent may refer to solvents that contain water as their main component. For example, the aqueous solvent may include water. In addition, the aqueous solvent may further include at least one of methanol, ethanol, ethylene glycol, diethylene glycol, and glycerol.

In an example embodiment, the first binder BND1 and the solvent may be mixed to form a binder solution. The first binder BND1 may be present in an amount in a range of about 0.5 wt % to about 10 wt % in the binder solution. For example, the amount of the first binder BND1 in the binder solution may be in a range of about 0.5 wt % to about 5 wt %, about 0.8 wt % to about 3.5 wt %, or about 0.8 wt % to about 3 wt %, or may be about 1 wt %.

The negative electrode material MAT may include a carbon-based material CCM and a metal particle MTP. The weight ratio of the carbon-based material CCM and the metal particle MTP in the negative electrode material MAT may be, for example, in a range of about 1:1 to about 8:1.

In an example embodiment, the carbon-based material CCM may have a particle shape. An average particle diameter (D₅₀) of the carbon-based material CCM may range from about 10 nm to about 1 μm. For example, the average particle diameter (D₅₀) of the carbon-based material CCM may be equal to or greater than about 10 nm, 20 nm, or 30 nm. For example, the average particle diameter (D₅₀) of the carbon-based material CCM may be equal to or less than about 1 μm, 100 nm, 70 nm, or 50 nm.

When the average particle diameter (D₅₀) of the carbon-based material CCM falls within the range above, an all-solid-battery may have an increased lifetime and a minimum change in volume during charge and discharge.

The carbon-based material CCM may include at least one of non-graphitizable carbon (or hard carbon) and graphitizable carbon (or soft carbon). For example, the carbon-based material CCM may include non-graphitizable carbon (or hard carbon).

For example, the carbon-based material CCM may include at least one of carbon black, carbon nano-tube, acetylene black, furnace black, ketjen black, and graphene. The carbon-based material CCM, however, is not limited to the examples described above.

The carbon-based material CCM may have at least one of a spherical shape, an oval shape, a plate shape, and a combination thereof. The shape of the carbon-based material CCM, however, is not limited to the examples described above.

The metal particle MTP may include at least one of gold (Au), platinum (Pt), palladium (Pd), silicon (Si), silver (Ag), aluminum (Al), bismuth (Bi), tin (Sn), zinc (Zn), magnesium (Mg), titanium (Ti), gallium (Ga), zinc oxide (ZnO), germanium (Ge), lead (Pb), antimony (Sb), and indium (In). For example, the metal particle MTP may include at least one of silver (Ag), magnesium (Mg), bismuth (Bi), gold (Au), platinum (Pt), zinc (Zn), and a combination thereof. The metal particle MTP according to an example embodiment of the present disclosure may be or include a nano-particle.

The metal particle MTP according to an example embodiment of the present disclosure may include a lithiophilic metal. The lithiophilic metal may exhibit characteristics represented by Equation 1.

$$△ G = △ {H}_{523.15 K} - {T△S}_{523.15 K} \leq 0 . \qquad Equation l$$

For example, at about 250° C., the lithiophilic metal may have a Gibbs free energy ΔG that is equal to or less than about 0 kJ/mol in a chemical reaction with molten lithium. For example, at about 250° C., the Gibbs free energy ΔG of the chemical reaction between the metal particle MTP and the molten lithium may range from about −1,500 kJ/mol to about 0 kJ/mol. The lithiophilic metal and lithium may spontaneously form an alloy under the above condition.

Referring to FIG. 4, the mixture MXT may be mixed by a mixer MXD. In an example embodiment, a planetary mixer may be utilized to perform the mixing process at a temperature in a range of about 20° C. to about 60° C. for a duration in a range of about 20 minutes to about 300 minutes. During the mixing process, the binder solution may be added to allow the first binder BND1 to have an amount in a range of about 1 wt % to about 5 wt % in the first mixture MTX1.

The mixing process may cause the mixture MXT to have a viscosity in a range of about 500 cps to about 4,000 cps. For example, the viscosity of the mixture MXT may range from about 1,000 cps to about 3,500 cps, or from about 1,500 cps to about 3,000 cps.

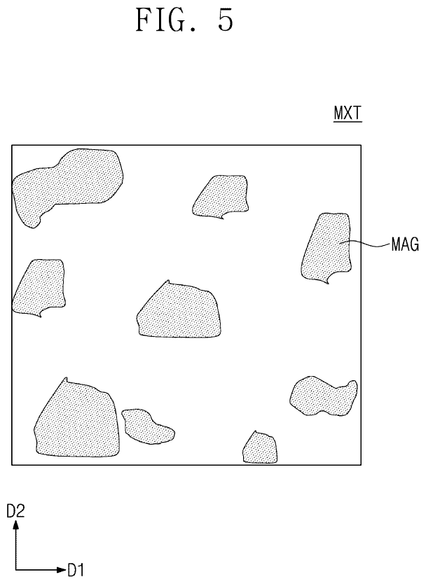

FIG. 5 illustrates a plan view of an enlarged portion of a mixture a MXT after the mixing process. Referring to FIG. 5, a negative electrode material in the form of a macro-aggregate MAG may exist in the mixture MXT. The macro-aggregate MAG may be or include an aggregate of metal particles, an aggregate of carbon-based materials, or an aggregate of carbon-based materials and metal particles together.

The macro-aggregates MAG may have a particle size of about 100 μm or larger and may exist in various forms. In an example embodiment, an aggregate having a particle size of 100 μm or larger may refer to an aggregate having a major axis of 100 μm or longer, wherein the major axis refers to the longest diameter of the aggregate. In another example embodiment, an aggregate having a particle size of 100 μm or larger may refer to an aggregate having a volume greater than the volume of a sphere having a diameter of 100 μm. In yet another example embodiment, an aggregate having a particle size of 100 μm or larger may refer to an aggregate which area, as observed in a two-dimensional image, is greater than the area of a circle having a diameter of 100 μm.

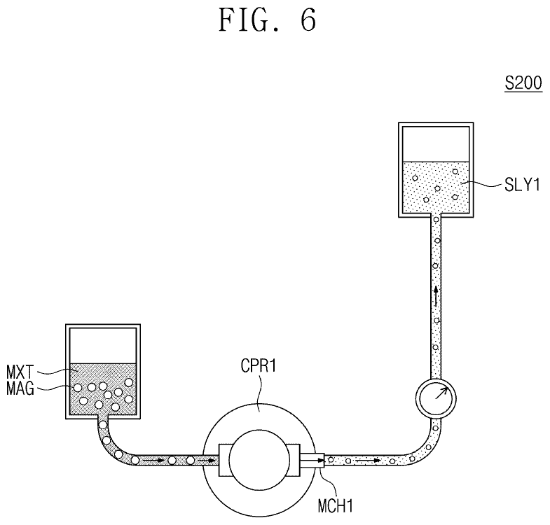

With reference to FIG. 6, the first slurry SLY1 may be formed by performing a pre-dispersion process on the mixture MXT (S₂₀₀).

The main dispersion process, which is described below, is performed using a high-pressure dispersion method under an operating pressure of about 500 bar or more. When the main dispersion process is performed directly on the mixture MXT without a pre-dispersion process, the macro-aggregates MAG may block the dispersion nozzle, causing the main dispersion process to be halted. The pre-dispersion process may primarily crush the macro-aggregates MAG before the main dispersion process, allowing the main dispersion to proceed more smoothly.

The pre-dispersion process may be performed using a disperser. The type of the disperser is not limited as long as the disperser can apply a shear force or an impact force to the mixture. For example, the disperser may be a high-pressure homogenizer, a bead mill, a ball mill, a spike mill, a basket mill, an attrition mill, or an ultrasonic disperser.

In an example embodiment, referring to FIG. 2 and FIG. 6, the pre-dispersion process may be performed by a high-pressure disperser. For example, the mixture MXT may be pressurized to a high pressure by the compressor CPR1. The mixture MXT may be pressurized to a pressure in a range of about 100 bar to about 500 bar. For example, the mixture MXT may be pressurized to a pressure of about 400 bar. The pressure applied in the pre-dispersion process may be lower than the pressure applied in the main dispersion process to be described below. Prior to the main dispersion, a pre-dispersion process may be performed at a lower pressure to break down the macro-aggregates and facilitate the main dispersion process.

As the mixture MXT is pressurized to a high pressure, the mixture MXT may simultaneously or contemporaneously pass through the grinding nozzle. The diameter of the grinding nozzle MCH1 used in the pre-dispersion process may be larger than the diameter of the grinding nozzle used in the main dispersion process. Prior to the main dispersion, a pre-dispersion process may be performed using a grinding nozzle with a larger diameter to break down the macro-aggregates and facilitate the main dispersion process. The diameter of the grinding nozzle MCH1 that is used in the pre-dispersion process may range from about 200 μm to about 500 μm. For example, the diameter of the grinding nozzle MCH1 may be about 300 μm.

When the pre-dispersion process is performed using a high-pressure disperser, the viscosity of the first slurry SLY1 may be lower than the viscosity of the mixture MXT. The viscosity of the first slurry SLY1 may range from about 1000 cps to about 3000 cps. For example, the viscosity of the first slurry SLY1 may range from about 1000 cps to about 2000 cps. In the present disclosure, viscosity may refer to the viscosity measured at room temperature (23° C.) and a shear rate of 10 (l/s).

The high-pressure disperser is not limited to the equipment illustrated in FIG. 6, and any equipment capable of performing a high-pressure dispersion process on the mixture MXT may be used without limitation.

In an example embodiment, referring to FIG. 2 and FIG. 7, the pre-dispersion process may be performed using a bead mill BDM device. The bead mill BDM may break down and disperse the macro-aggregates MAG and form the first slurry by applying a physical impact to the mixture MXT using beads BD, which constitutes a grinding media.

The average particle diameter (D₅₀) of the beads BD may be about 0.5 mm or larger. For example, the average particle diameter (D₅₀) of the beads BD may be in a range of about 0.5 mm to about 5 mm, about 0.6 mm to about 4 mm, about 0.6 mm to about 3 mm, or about 0.8 mm to about 2 mm. In an example embodiment, the average particle diameter (D₅₀) of the beads BD may be equal to about 0.8 mm. The rotational speed of the bead mill BDM may range from about 1000 rpm to about 5000 rpm. In one example embodiment, the rotational speed of the bead mill may be equal to about 3000 rpm.

When the pre-dispersion process is performed using a bead mill BDM, the viscosity of the first slurry SLY1 may be higher than the viscosity of the mixture MXT. The viscosity of the first slurry SLY1 may range from about 2000 cps to about 5000 cps. For example, the viscosity of the first slurry SLY1 may range from about 3000 cps to about 4500 cps.

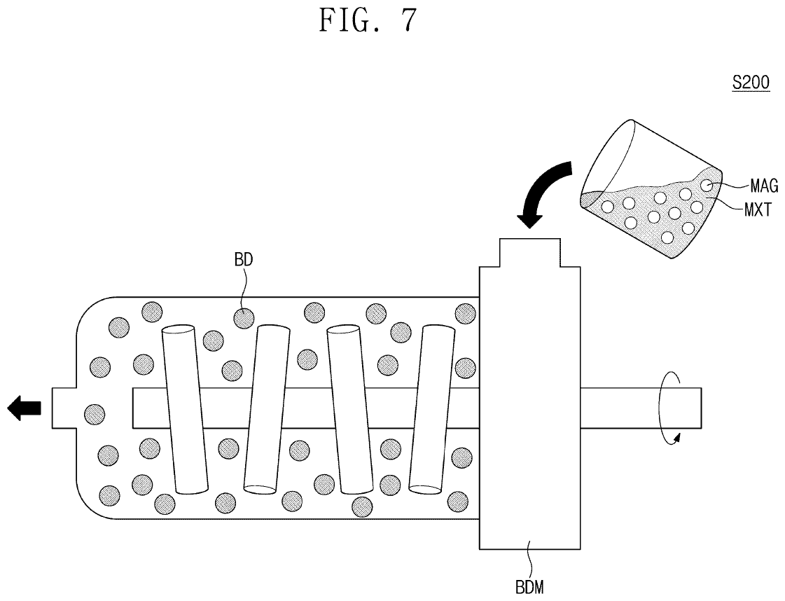

FIG. 8 illustrates a plan view of an enlarged portion of the first slurry SLY1 according to an example embodiment of the present disclosure. Referring to FIG. 8, the first slurry SLY1 that has undergone the pre-dispersion process may include aggregates AG. The particle size of the aggregates AG may be about 50 μm or larger. For example, the particle size of the aggregate AG may range from about 50 μm to about 100 μm. The particle size of the aggregate AG included in the first slurry may be smaller than the particle size of the macro-aggregate MAG described above with reference to FIG. 5. According to an example embodiment, the first slurry SLY1 may not include aggregates with a particle size of about 100 μm or larger.

The aggregate AG may be or include an aggregate of metal particles, an aggregate of carbon-based materials, or an aggregate of carbon-based materials and metal particles together. The aggregate AG may have various shapes and forms.

In an example embodiment, an aggregate having a particle size of about 50 μm or larger may refer to an aggregate which major axis is 50 μm or longer, wherein the major axis refers to the longest diameter of the aggregate. In another example embodiment, an aggregate having a particle size of 50 μm or larger may refer to an aggregate having a volume greater than the volume of a sphere having a diameter of 50 μm. In yet another example embodiment, an aggregate having a particle size of 50 μm or larger may refer to an aggregate which area, as observed in a two-dimensional image, is greater than the area of a circle having a diameter of 50 μm.

In a two-dimensional image of the first slurry SLY1, the number of aggregates AG per 25 mm² area may be about 30 or less. The two-dimensional image may be a photograph taken after the first slurry SLY1 has been coated and dried on a substrate. The two-dimensional image may be an optical microscope photograph (OM), a scanning electron microscope (SEM) image, a transmission electron microscope (TEM), or the like. The two-dimensional image may be, for example, an optical microscope photograph.

Counting the aggregates AG on the two-dimensional image may include performing image processing on the two-dimensional image and counting the number of aggregates having a particle size greater than about 50 μm in the image-processed result.

In an example embodiment, the image processing and counting of the number of aggregates may be performed using the Image J program. For example, in an optical microscope photograph of the first slurry SLY1, a specific area corresponding to an area of 25 mm² may be selected. Then the selected area may be magnified at a magnification of 50, and the “Thresholding” function may be applied to the magnified image to distinguish the aggregates from the background. Thereafter, the “Analyze Particles” function may be executed on the image to which thresholding has been applied, and a reference value may be set to count aggregates with an area larger than the area of a circle having a diameter of 50 μm. This may allow for the counting of aggregates having a particle size of 50 μm or larger. The process of counting the number of aggregates using the above method may be repeated at least eight times, and the average value may be considered as the number of the aggregates AG per 25 mm² area.

The pre-dispersion process may be repeatedly performed about 1 to 5 times so that the number of aggregates AG having a particle size of 50 μm or larger per 25 mm² area in the two-dimensional image of the first slurry SLY1 is about 30 or less. When the number of the aggregates AG in the first slurry SLY1 satisfies the above-described range, the main dispersion process, which is described below, may proceed smoothly without clogging the grinding nozzle.

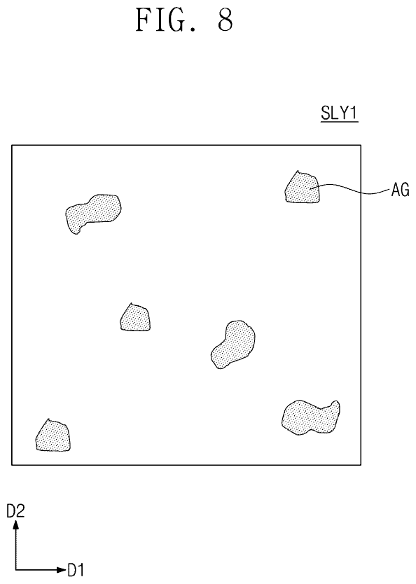

Referring to FIG. 2 and FIG. 9, the second slurry SLY2 may be formed by performing a main dispersion process on the first slurry SLY1 (S₃₀₀).

The main dispersion process may be performed by a high-pressure dispersion method using a high-pressure disperser. For example, the first slurry SLY1 may be pressurized to a high pressure by the compressor CPR2. The first slurry SLY1 may be pressurized to a pressure of about 500 bar or more. For example, the first slurry SLY1 may be pressurized to a pressure in a range of about 500 bar to about 1,500 bar. As described above, the pressure applied in the main dispersion process may be greater than the pressure applied in a pre-dispersion process.

As the first slurry SLY1 is pressurized to a high pressure, the first slurry SLY1 may simultaneously or contemporaneously pass through the grinding nozzle MCH2. As described above, the diameter of the grinding nozzle MCH2 used in the main dispersion process may be smaller than the diameter of the grinding nozzle used in the pre-dispersion process. The diameter of the grinding nozzle MCH2 used in the main dispersion process may range from about 50 μm to about 250 μm. For example, the diameter of the grinding nozzle MCH2 may be about 100 μm.

By performing the main dispersion process using a grinding nozzle with a smaller diameter under high operating pressure, the second slurry SLY2 with more uniformly dispersed negative electrode material can be prepared.

As with the pre-dispersion, the disperser used in the main dispersion process is not limited to the equipment illustrated in FIG. 9, and any equipment capable of performing the high-pressure dispersion process on the first slurry SLY1 may be used without limitation.

A final negative electrode slurry, i.e., a coating slurry, may be prepared by mixing the second binder with the second slurry SLY2.

The second binder may exhibit desired or improved adhesion. For example, the second binder may include at least one of rubber-based binder, imide-based binder, nitrile-based binder, acetate-based binder, a cyano-based binder, and a combination thereof.

The rubber-based binder may be or include, for example, at least one of styrene-butadiene rubber (SBR) or nitrile-butadiene rubber (NBR).

The imide-based binder may be or include, for example, polyimide or polyamide imide.

The nitrile-based binder may be or include, for example, polyacrylonitrile or acrylonitrilestyrene-butadiene copolymer.

The acetate-based binder may be or include, for example, at least one of polyvinylacetate, ethylene-co-vinyl acetate, cellulose acetate, cellulose acetate butyrate, or cellulose acetate propionate.

The cyano-based binder may be or include, for example, cyanoethyl sucrose.

In an example embodiment, the second binder may be or include a rubber-based binder. The second binder may be different from the first binder BND1.

In one example embodiment, the second binder may be provided in a solution state dissolved in a solvent. For example, the solvent may be or include an aqueous solvent or a non-aqueous solvent as described above. In one example embodiment, the solvent may be or include water.

The second binder may be mixed with the second slurry SLY2. The mixing method is not limited. In an example embodiment, the mixing may be performed by adding the second binder to the second slurry SLY2, and stirring the mixture using a planetary mixer at a temperature in a range of about 20° C. to about 60° C. for a duration in a range of about 20 minutes to about 250 minutes.

In the mixing process, the second binder may be added so that the amount of the second binder in the coating slurry is in a range of about 3 wt % to about 10 wt % based on solid content, and in a range of about 0.5 wt % to about 5 wt % based on the slurry containing the solvent. For example, the amount of the second binder in the coating slurry may be about 5.5 wt % based on solid content and about 1.5 wt % based on the slurry containing the solvent. In this description, solid content may refer to all components in the slurry (or mixture) except for the solvent. For example, the solid content in coating slurry may include the negative electrode material MAT, the first binder BND1 and the second binder.

When the amount of the second binder in the coating slurry satisfies the above range, the final slurry may achieve appropriate adhesion and viscosity, thereby improving coating adhesion and dispersion stability.

The total amount of the first binder and the second binder in the coating slurry may range from about 1 wt % to about 10 wt % based on solid content. When the amount of the first and second binders in the final slurry is less than the above range, the negative electrode material MAT may not be sufficiently dispersed. When the content of the first and second binders is greater than the above range, the first and the second binders may excessively adsorb onto the surface of the carbon-based material CCM and/or the metal particle MTP, hindering the movement of lithium ions and increasing the internal resistance of the battery.

The viscosity of the coating slurry mixed with the second binder may range from about 300 cps to about 1000 cps. For example, the viscosity of the coating slurry may range from about 300 cps to about 900 cps, or about 300 cps to about 800 cps.

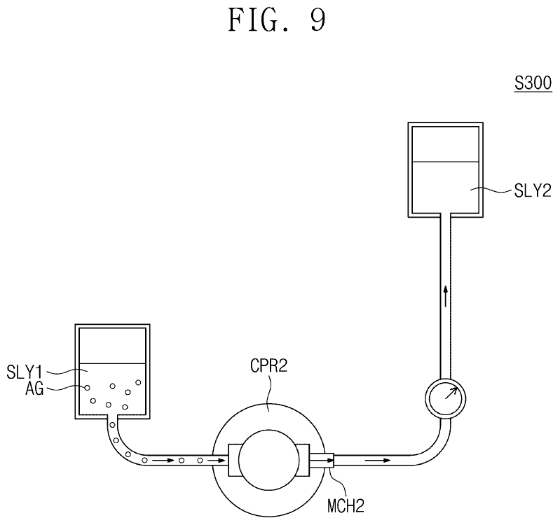

FIG. 10 illustrates a plan view of an enlarged portion of a coating slurry according to an example embodiment of the present disclosure. Referring to FIG. 10, the coating slurry CSL may include a first aggregate AG1 and a second aggregate AG2. The first aggregate AG1 may refer to an aggregate having a particle size of 20 μm or larger, and the second aggregate AG2 may refer to an aggregate having a particle size of 50 μm or larger. The aggregate having a particle size of 50 μm or larger may be or include both the first aggregate AG1 and the second aggregate AG2.

Each of the first and second aggregates AG1, AG2 may be or include an aggregate of metal particles, an aggregate of carbon-based materials, or an aggregate of carbon-based materials and metal particles together. The first and second aggregates AG1, AG2 may have various shapes and forms.

In an example embodiment, the first aggregate AG1 having a particle size of 20 μm or larger may refer to an aggregate whose major axis is 20 μm or longer, wherein the major axis refers to the longest diameter of the aggregate. In another example embodiment, the first aggregate AG1 may refer to an aggregate having a volume greater than the volume of a sphere having a diameter of 20 μm. In yet another example embodiment, the first aggregate AG1 may refer to an aggregate whose area, as observed in a two-dimensional image, is greater than the area of a circle having a diameter of 20 μm.

In an example embodiment, the second aggregate AG2 having a particle size of 50 μm or larger may refer to an aggregate having a major axis of 50 μm or longer, wherein the major axis refers to the longest diameter of the aggregate. In another example embodiment, the second aggregate AG2 may refer to an aggregate having a volume greater than the volume of a sphere having a diameter of 50 μm. In yet another example embodiment, the second aggregate AG2 may refer to an aggregate having an area, as observed in a two-dimensional image, that is greater than the area of a circle having a diameter of 50 μm.

In a two-dimensional image of the coating slurry CSL the number of the first aggregates AG1 per 25 mm² may be about 50 or less. The two-dimensional image may be a photograph taken after the coating slurry CSL has been coated and dried on a substrate. The two-dimensional image may be an optical microscope photograph (OM), a scanning electron microscope (SEM) image, a transmission electron microscope (TEM), or the like. The two-dimensional image may be, for example, an optical microscope photograph.

Counting the first aggregates AG1 on the two-dimensional image may include performing image processing on the two-dimensional image and counting the number of aggregates having a particle size greater than 20 μm in the image-processed result.

In an example embodiment, the image processing and counting of the number of aggregates may be performed using the Image J program. For example, in an optical microscope photograph of the coating slurry CSL, a specific area corresponding to an area of about 25 mm² may be selected. Then the selected area may be magnified at a magnification of 50, and the “Thresholding” function may be applied to the magnified image to distinguish the aggregates from the background. Thereafter, the “Analyze Particles” function may be executed on the image to which thresholding has been applied, and a reference value may be set to count aggregates with an area larger than the area of a circle having a diameter of 20 μm. This may allow for the counting of aggregates having a particle size of 20 μm or larger. The process of counting the number of aggregates using the above method may be repeated at least eight times, and the average value may be considered as the number of the first aggregates AG1 per 25 mm² area.

In a two-dimensional image of the coating slurry CSL the number of the second aggregates AG2 per 25 mm² may be about 3 or less. For example, the number of the second aggregates AG2 per 25 mm² may be about 2 or less, or about 1 or less. The two-dimensional image may be a photograph taken after the coating slurry CSL has been coated and dried on a substrate. The two-dimensional image may be an optical microscope photograph (OM), a scanning electron microscope (SEM) image, a transmission electron microscope (TEM), or the like. The two-dimensional image may be, for example, an optical microscope photograph.

Counting the second aggregates AG2 on the two-dimensional image may include performing image processing on the two-dimensional image and counting the number of aggregates having a particle size greater than 50 μm in the image-processed result.

In an example embodiment, the image processing and counting of the number of aggregates may be performed using the Image J program. For example, in an optical microscope photograph of the coating slurry CSL, a specific area corresponding to an area of 25 mm² may be selected. Then the selected area may be magnified at a magnification of 50, and the “Thresholding” function may be applied to the magnified image to distinguish the aggregates from the background. Thereafter, the “Analyze Particles” function may be executed on the image to which thresholding has been applied, and a reference value may be set to count aggregates with an area larger than the area of a circle having a diameter of 50 μm. This may allow for the counting of aggregates having a particle size of 50 μm or larger. The process of counting the number of aggregates using the above method may be repeated at least eight times, and the average value may be considered as the number of the second aggregates AG2 per 25 mm² area.

The coating slurry manufactured by the above-described method may have substantially uniformly dispersed negative electrode material. The negative electrode for an all-solid-state battery manufactured by applying the negative electrode slurry with desired or improved dispersibility, may have a uniform coating layer. When the coating layer is formed substantially uniformly, lithium can be substantially evenly electrodeposited in the charging process, and the growth of lithium dendrites may be reduced or suppressed. This may improve the stability and lifespan characteristics of the battery.

The present disclosure is discussed below in detail through example embodiments. These example embodiments, however, are provided to illustrate the present disclosure, and the scope of the present disclosure is not limited to these embodiments.

### Embodiment 1

1) Silver (Ag) and carbon black were mixed to prepare a negative electrode material. Silver and carbon black were mixed in a weight ratio of 25:75 to constitute a composition of the negative electrode material.

2) An aqueous solution of carboxymethyl cellulose (CMC) containing 1.3 wt % of solid content was added to the negative electrode material, and then mixed at a temperature of 25° C. for 160 minutes using a planetary mixer to prepare a mixture in the form of slurry. Specifically, the mixing was performed by stirring the coating material and the CMC aqueous solution at a weight ratio of 30:70.

3) A high-pressure dispersion process (pre-dispersion process) was performed on the mixture using Micronox MN-400BF (a high-pressure homogenizer). Specifically, the mixture was pressurized to 400 bar and passed through a grinding nozzle with a diameter of 300 μm. The high-pressure dispersion process was repeated twice to obtain a first slurry.

4) A high-pressure dispersion process (main dispersion process) was performed on the first slurry using Micronox MN-400BF (a high-pressure homogenizer). Specifically, the mixture was pressurized to 1400 bar and passed through a nozzle with a diameter of 100 μm. The high-pressure dispersion process was repeated twice to obtain a second slurry.

5) After the main dispersion process, a water-based dispersion containing styrene-butadiene rubber (SBR) was added to the second slurry. The mixture was then stirred at 25° C. for 60 minutes to prepare a final coating slurry. Specifically, the mixing was performed by stirring the second slurry and the water-based dispersion at a weight ratio of 97:3. Ultimately, a coating slurry having a solid content of 21 wt % was prepared.

6) The coating slurry was applied to the surface of a stainless steel (SUS) current collector using a doctor blade to a thickness of 40 μm, and then the coating layer was dried in an oven at 80° C.

### Embodiment 2

In the pre-dispersion process of Embodiment 1, a bead mill was used instead of Micronox MN-400BF (high pressure homogenizer). The mixture was introduced into a bead mill (containing beads having an average particle diameter of 0.8 mm) and the dispersion process was performed at a rotational speed of 3500 rpm. The dispersion process using the bead mill was repeated twice. Except for this, the preparation was carried out in the same manner as in Embodiment 1.

### Comparative Embodiment 1

The preparation was carried out in the same manner as Embodiment 1, with a difference that the pre-dispersion process was omitted.

### Comparative Embodiment 2

In the pre-dispersion process of Embodiment 1, an Omega disperser was used instead of Micronox MN-400BF (high pressure homogenizer). Specifically, the mixture was pressurized to a medium/low pressure of 80 bar and passed through a large nozzle having a diameter of 500 μm. The pre-dispersion process was repeated twice to form a second slurry. Except for this, the preparation was carried out in the same manner as in Embodiment 1.

### Comparative Embodiment 3

In the pre-dispersion process of Embodiment 1, a colloid mill was used instead of Micronox MN-400BF (high pressure homogenizer). Specifically, the gap of the colloid mill was set to 50 μm, and the dispersion process was performed for 30 minutes. Except for this, the preparation was carried out in the same manner as in Embodiment 1.

The pre-dispersion processes of Embodiments 1 and 2 and Comparative Embodiments 1 to 3 described above are summarized in Table 1 below.

TABLE 1

| | | | Repetition |
|---|---|---|---|
| | Pre-Dispersion | Pre-Dispersion Device | number |
| Embodiment 1 | ◯ | High Pressure | 2 |
| | | Disperser | |
| Embodiment 2 | ◯ | Bead Mill | 2 |
| Comparative | X | | — |
| Example 1 | | | |
| Comparative | ◯ | Omega | 2 |
| Example 2 | | | |
| Comparative | ◯ | Colloid Mill | 1 |
| Example 3 | | | |

### Manufacture of Positive Electrode Layer

A powder of LiNi_{0.8}Co_{0.15}Mn_{0.05}O₂ (NCM) was prepared as a positive electrode active material. An argyrodite-type crystal, Li₆PS₅Cl solid electrolyte (D₅₀=1 μm or less, crystalline), was used as a solid electrolyte. Polytetrafluoroethylene (PTFE, Teflon from Dupont Co.) was prepared as a binder, and carbon black (CB) and carbon nano-fiber (CNF) were prepared as conductive material. The positive electrode active material, the solid electrolyte, the carbon black, the carbon nano-fiber, and the binder were mixed in a weight ratio of 85.5:10:1.5:1.5:1.5 in a xylene solvent to form a positive electrode active material composition in the form of sheet, and then the mixture was vacuum dried at 40° C. for 8 hours to manufacture a positive electrode layer.

### Manufacture of Solid Electrolyte Layer

An acryl-based binder (SX-A334 from Zeon Co. Ltd.) was added to octyl acetate to prepare a binder solution of 4 wt %. The prepared acryl-based binder solution was added to an argyrodite-type crystal, Li₆PS₅Cl solid electrolyte (D₅₀=3 μm, crystalline), and Thinky Mixer was used to mix and prepare a slurry. In the slurry, the acryl-based binder was included in an amount of 1.5 parts by weight relative to 98.5 parts by weight of the solid electrolyte. A bar coater was used to coat the prepared slurry on a non-woven fabric, and dried for 10 minutes in a convection oven at 80° C., thereby obtaining a stack. The stack was vacuum dried for 2 hours at 70° C.

### Manufacture of All-Solid-State Battery

A stack was prepared by placing the solid electrolyte layer between the positive electrode layer and the negative electrode layer. The prepared stack was subject to isostatic pressing at 80° C. for 30 minutes under a pressure of 490 MPa to fabricate an all-solid-state battery. The solid electrolyte layer was sintered through the pressing treatment to improve battery characteristics. A thickness of the sintered solid electrolyte layer was about 45 μm. A thickness of the pressed positive electrode active material layer was about 120 μm, a thickness of the coating layer was as discussed above, and a thickness of the solid electrolyte layer was about 120 μm.

### Evaluation Example 1: Analysis of First Slurry

### (1) Analysis of Optical Microscope Photograph

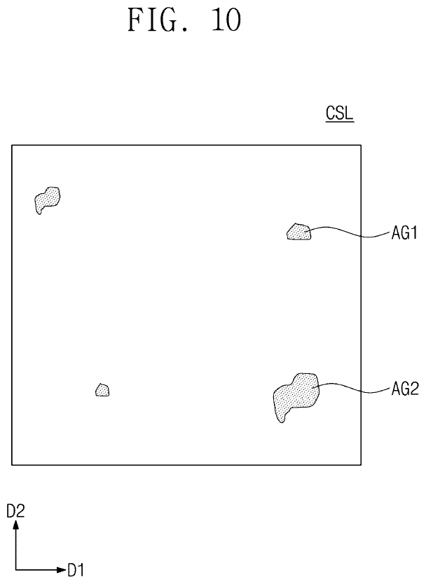

The first slurry prepared according to the above-mentioned Embodiments and Comparative Embodiments was coated onto a substrate, dried, and then imaged using an optical microscope. A portion of the optical microscope photograph is shown in FIG. 11 to FIG. 13. In Comparative Embodiment 1, since the pre-dispersion process was not performed, the mixture was regarded as the first slurry, an optical microscope photograph was taken of the mixture.

Referring to FIG. 11, which is an optical microscope photograph of the first slurry prepared according to Embodiment 1, it can be observed that the first slurry which underwent the pre-dispersion process using a high-pressure dispersion method contains relatively smaller aggregates.

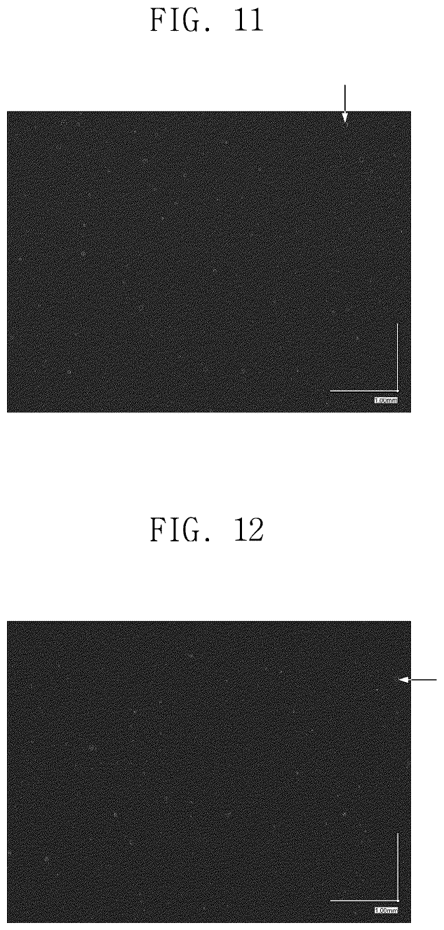

Referring to FIG. 12, which is an optical microscope photograph of the first slurry prepared according to Embodiment 2, it can be observed that the first slurry which underwent the pre-dispersion process using the bead mill contains relatively smaller aggregates.

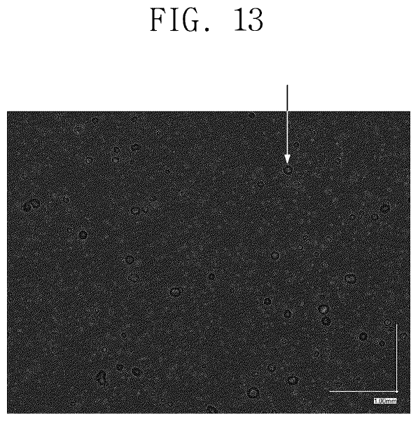

Referring to FIG. 13, which is an optical microscope photograph of the mixture prepared according to Comparative Embodiment 1, it can be observed that the mixture which did not undergo the pre-dispersion process contains a large number of relatively larger aggregates.

### (2) Analysis of Number of Aggregates

The Optical Microscope Photographs were analyzed, and the number of aggregates having a particle size of 50 μm or lager and 100 μm or lager were counted, respectively, and the results are shown in Table 2 below. In Comparative Embodiment 1, since the pre-dispersion process was not performed, the mixture was regarded as the first slurry, and the number of aggregates in the optical microscope photograph of Comparative Embodiment 1 was counted.

For counting the number of aggregates, a specific area corresponding to an area of 25 mm² was selected from the optical microscope photograph of the first slurry. The selected area was then enlarged at a magnification of 50, and a “Thresholding” function was applied to the magnified image to distinguish the aggregates from the background. Subsequently, the “Analyze Particles” function was executed on the image to which thresholding has been applied, and a reference value was set to count aggregates having an area larger than the area of a circle having a diameter of 50 μm. This allowed for counting of aggregates with a particle size of 50 μm or larger.

Thereafter, a reference value was set to count aggregates having an area larger than the area of a circle having a diameter of 100 μm. This allowed for counting of aggregates with a particle size of 100 μm or lager.

The counting of the aggregates was repeated 8 times, and the average of the number of the aggregates was determined. The obtained values are shown in Table 2 below.

TABLE 2

| | | Number of | Number of |
|---|---|---|---|
| | Pre-Dispersion | Aggregates 50 | Aggregates 100 |
| | Device | μm or larger | μm or larger |
| Embodiment 1 | High Pressure | 20 | 0 |
| | Disperser | | |
| Embodiment 2 | Bead Mill | 18 | 0 |
| Comparative | | 97 | 15 |
| Example 1 | | | |
| Comparative | Omega | 88 | 6 |
| Example 2 | | | |
| Comparative | Colloid Mill | 51 | 1 |
| Example 3 | | | |

Referring to Table 2, it can be observed that in the first slurry prepared according to the Embodiments, the number of aggregates having a particle size of 50 μm or larger is less than 30, and there are no aggregates having a particle size of 100 μm or larger.

### Evaluation Example 2: Analysis of Coating Slurry

The coating slurry prepared according to the above-described Embodiments and Comparative Embodiments was coated onto a substrate, dried, and then imaged using an optical microscope. The Optical Microscope Photographs were analyzed, and the number of aggregates having a particle size of 20 μm or lager and 50 μm or lager were counted, respectively, and the results are shown in Table 3 below. In Comparative Embodiment 1, since nozzle clogging occurred in the main dispersion process and the final slurry was not prepared, the number of aggregates in the coating slurry was not counted.

The method for counting the number of aggregates is the same as the method used in Evaluation Example 1.

TABLE 3

| | | Number of | Number of |
|---|---|---|---|
| | Pre-Dispersion | Aggregates 20 | Aggregates 50 |
| | Device | μm or larger | μm or larger |
| Embodiment 1 | High Pressure | 15 | 0 |
| | Disperser | | |
| Embodiment 2 | Bead Mill | 21 | 0 |
| Comparative | Omega | 73 | 5 |
| Example 2 | | | |
| Comparative | Colloid Mill | 61 | 3 |
| Example 3 | | | |

Referring to Table 3, it can be observed that in the coating slurry prepared according to the Embodiments, the number of aggregates having a particle size of 20 μm or larger is less than 30, and there are no aggregates having a particle size of 50 μm or larger.

### Evaluation Example 3: Evaluation of Negative Electrode Layer and All-Solid-State Battery

The lifespan of the all-solid-state batteries including the negative electrode layers according to Embodiments 1 and 2 and Comparative Embodiments 2 and 3 was evaluated. In Comparative Embodiment 1, since nozzle clogging occurred in the main dispersion process and the final slurry was not prepared, the lifespan evaluation could not be performed.

The lifespan evaluation was performed by setting the clamping pressure of the pressurizing device of the all-solid-state battery to 4 MPa. The lifespan evaluation was performed by repeatedly charging the all-solid-state battery at a constant current of 0.33 C until the voltage reached 4.25 V, and then discharging the all-solid-state battery at a constant current of 0.33 C until a voltage reached 2.5 V. The lifespan (charge/discharge efficiency) was calculated according to Equation 2 below. The results are shown in Table 4 below.

$$Lifespan ( \% ) = ( Discharge capacity at {100}^{th} cycle / Discharge capacity at {1}^{st} cycle ) \times 100 \qquad Equation 2$$

TABLE 4

| | Lifespan (%) |
|---|---|
| Embodiment 1 | 80.5 |
| Embodiment 2 | 83.1 |
| Comparative Embodiment 2 | 74.3 |
| Comparative Embodiment 3 | 76.6 |

Referring to Table 4, it can be observed that the all-solid-state batteries including the coating layers according to the Embodiments exhibit improved lifespan characteristics compared he Comparative Embodiments. This may be attributed to the uniform formation of the coating layer.

In a negative electrode slurry for an all-solid-state battery according to examples of the present disclosure, the dispersibility and long-term stability of a negative electrode material containing a carbon-based material and a metal may be improved. The negative electrode manufactured using the negative electrode slurry may exhibit desired or improved performance.

While the present disclosure has been described with reference to example embodiments, it should be understood that these example embodiments are provided for illustrative purposes only and do not limit the scope of the present disclosure. Various modifications and equivalent arrangements may be made without departing from the spirit and scope of the appended claims. Accordingly, the described embodiments should be regarded as examples rather than limitations of the present disclosure.

What is claimed is:

1. A method for manufacturing a negative electrode slurry for an all-solid-state battery, the method comprising:
mixing a binder solution comprising a solvent and a first binder with a negative electrode material to form a mixture;
performing a pre-dispersion process on the mixture to form a first slurry; and
performing a main dispersion process on the first slurry to form a second slurry,
wherein the main dispersion process is performed by a high-pressure dispersion method under an operating pressure in a range of about 500 bar or more,
wherein, in a two-dimensional image of the first slurry, the number of aggregates per 25 mm² is in a range about 30 or less, and
wherein a particle size of the aggregates of the first slurry is in a range about 50 μm or larger.

2. The method of claim 1, wherein counting the number of the aggregates comprises:
performing image processing on the two-dimensional image; and
counting the number of aggregates having an area of 1963.5 μm² or more in the image-processed result.

3. The method of claim 1, wherein the main dispersion process is performed using a high-pressure disperser comprising a grinding nozzle having a diameter in a range of about 50 μm to about 250 μm.

4. The method of claim 1, wherein the pre-dispersion process is performed by a high-pressure dispersion method under an operating pressure in a range of about 100 bar to about 500 bar.

5. The method of claim 4, wherein the pre-dispersion process is performed using a high-pressure disperser comprising a grinding nozzle having a diameter in a range of about 200 μm to about 500 μm.

6. The method of claim 1, wherein the pre-dispersion process is performed using a bead mill, and
wherein the bead mill comprises beads having an average particle diameter (D₅₀) in a range of about 0.2 mm to about 2 mm.

7. The method of claim 1, wherein the pre-dispersion process is repeated about 1 to 5 times.

8. The method of claim 1, wherein the main dispersion process is repeated about 2 to 10 times.

9. The method of claim 1, further comprising adding a second binder to the second slurry.

10. The method of claim 1, wherein the negative electrode material comprises a carbon-based material and a metal particle, and
wherein the weight ratio of the carbon-based material and the metal particle range from about 1:1 to about 8:1.

11. The method of claim 10, wherein the carbon-based material comprises at least one of carbon black, acetylene black, furnace black, carbon nanotube, ketjen black, graphene, and a combination thereof.

12. The method of claim 10, wherein the metal particle comprises at least one of gold (Au), indium (In), germanium (Ge), platinum (Pt), palladium (Pd), silicon (Si), silver (Ag), aluminum (Al), bismuth (Bi), tin (Sn), zinc (Zn), and a combination thereof.

13. The method of claim 1, wherein the first binder comprises at least one of acrylate-based binder, polyvinylidenefluoride-based binder, polyvinylpyrrolidone-based binder, polyvinylalcohol-based binder, cellulose-based binder and a combination thereof.

14. A method for manufacturing a negative electrode slurry for an all-solid-state battery, the method comprising:
mixing a binder solution comprising a solvent and a first binder with a negative electrode material to form a mixture;
performing a pre-dispersion process on the mixture to form a first slurry; and
performing a main dispersion process on the first slurry to form a second slurry;
wherein the pre-dispersion process is performed using at least one of a high-pressure disperser and a bead mill, and
wherein the main dispersion process is performed by a high-pressure dispersion method under an operating pressure in a range of about 500 bar or more.

15. The method of claim 14, wherein the main dispersion process is performed using a high-pressure disperser comprising a grinding nozzle having a diameter in a range of about 50 μm to about 250 μm.

16. The method of claim 14, wherein the pre-dispersion process is performed using a high-pressure disperser comprising a grinding nozzle having a diameter in a range of about 200 μm to about 500 μm, under an operating pressure in a range of about 100 bar to about 500 bar.

17. The method of claim 14, wherein the pre-dispersion process is performed using a bead mill comprising beads having an average particle diameter (D₅₀) in a range of about 0.2 mm to about 2 mm, and
wherein the bead mill has a rotation speed in a range of about 1000 rpm to about 5000 rpm.

18. The method of claim 14, wherein the pre-dispersion process is repeated about 1 to 5 times, and
wherein the main dispersion process is repeated about 2 to 10 times.

19. A negative electrode slurry for an all-solid-state battery manufactured by the method of claim 1,
wherein, in a two-dimensional image of the negative electrode slurry, the number of aggregates per 25 mm² is in a range of about 1 or less,
wherein a particle size of the aggregates is in a range of about 50 μm or larger, and
wherein the aggregates comprise a carbon-based material and a metal particle.

20. The negative electrode slurry for an all-solid-state battery of claim 19,
wherein the carbon-based material comprises at least one of carbon black, acetylene black, furnace black, carbon nanotube, ketjen black, graphene, and a combination thereof, and
wherein the metal particle comprises at least one of gold (Au), indium (In), germanium (Ge), platinum (Pt), palladium (Pd), silicon (Si), silver (Ag), aluminum (Al), bismuth (Bi), tin (Sn), zinc (Zn), and a combination thereof.
